(19) United States
(12) Patent Application Publication
(10) Pub. No.: US 2012/0277345 A1
(43) Pub. Date: Nov. 1, 2012

(54) MIX FOR PRODUCING TYRES WITH IMPROVED ROLLING RESISTANCE

(75) Inventors: Raffaele Di Ronza, Roma (IT); Francesco Botti, Roma (IT)

(73) Assignee: BRIDGESTONE CORPORATION, Chuo-ku, Tokyo (JP)

(21) Appl. No.: 13/510,722

(22) PCT Filed: Nov. 17, 2010
(86) PCT No.: PCT/IB2010/002930

§ 371 Date: Jul. 17, 2012

(30) Foreign Application Priority Data
Nov. 18, 2009 (IT) TO2009A000888

(51) Int. Cl. C09K 3/14; C08J 5/14

(52) U.S. Cl. 523/158; 523/152

(57) ABSTRACT

A mix for a structural component of a tyre, having a cross-linkable polymer base; curing agents; 20-100 phr of a reinforcing filler; and 2-16 phr of a methylene acceptor compound combined with a methylene donor compound. The reinforcing filler is defined by a blend of 20-80% by weight of carbon black classified as N1 or N2, and 80-20% by weight of carbon black classified as N5 or N6.

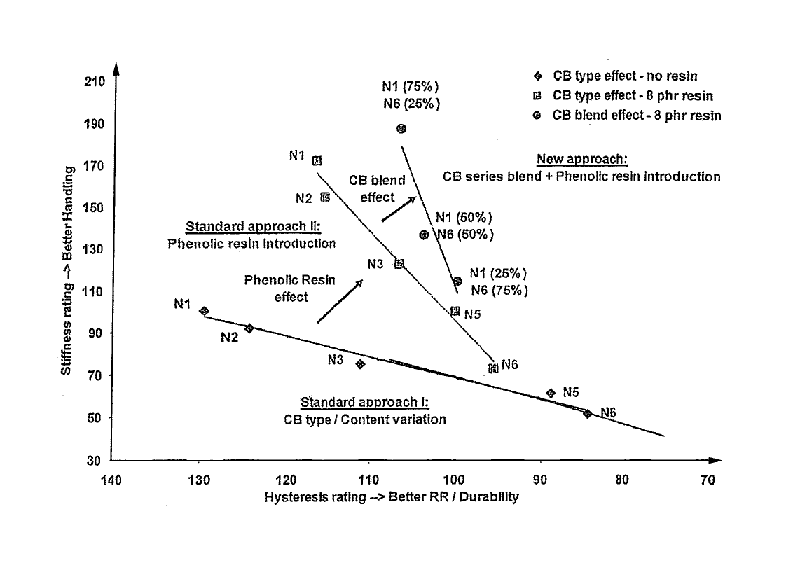

### TECHNICAL FIELD

The present invention relates to a mix for producing tyres with improved rolling resistance.

More specifically, the present invention relates to a mix for producing a structural tyre component, such as a TREAD UNDERLAYER, TREAD BASE or BEAD FILLER.

The term “cross-linkable, unsaturated-chain polymer base” is intended to mean any natural or synthetic non-cross-linked polymer capable of assuming all the chemical-physical and mechanical characteristics typical of elastomers when cross-linked (cured) with sulphur-based systems.

The term “curing agents” is intended to mean compounds, such as sulphur and accelerating agents, capable of cross-linking the polymer base.

The term “methylene donor compound” is intended to mean a cross-linking compound that forms methylene links in the presence of a “methylene acceptor” compound.

### BACKGROUND ART

As is known, a need is felt within the tyre industry for mixes capable of reducing the hysteresis, and so improving the rolling resistance, of tyre components, without compromising other characteristics, such as stiffness, affecting the handling performance of the tyre.

A common practice employed to modify the characteristics of individual components is to alter the quantity and type of carbon black used in the respective mixes.

Carbon black is classified as per ASTM Standard D1765 according to its surface area.

That is, depending on its surface area, carbon black is classified in ASTM Standard D1765 as N1, N2, N3, N5, N6, where N1 indicates a surface area of 121-150 m²/g; N2 a surface area of 100-120 m²/g; N3 a surface area of 70-99 m²/g; N4 a surface area of 40-49 m²/g; and N5 a surface area of 33-39 m²/g.

As anyone skilled in the art knows, high-surface-area carbon black improves stiffness, but increases the hysteresis rating and, hence, rolling resistance. Whereas, low-surface-area carbon black reduces the hysteresis rating and, hence, rolling resistance, but impairs stiffness.

To achieve a mix that provides for both good rolling resistance and easy handling, it is common practice to employ a mid-range carbon black (N3), or to combine two different carbon black classes to balance the stiffness and hysteresis characteristics. While not actually compromising either the hysteresis or stiffness characteristics, neither of these solutions provides for really significant results.

In Patent EP1677944, a phenolic resin is used as a “methylene acceptor” compound in combination with a “methylene donor” compound, to improve the stiffness and hysteresis properties of the mix.

The Applicant has surprisingly discovered a solution whereby to improve the rolling resistance of the tyre component, without impairing the necessary stiffness characteristics.

### DISCLOSURE OF INVENTION

According to the present invention, there is provided a mix for a structural component of a tyre, comprising a cross-linkable polymer base; curing agents; and 20-100 phr of a reinforcing filler; said mix being characterized by comprising 2-16 phr of a methylene acceptor compound combined with a methylene donor compound; and in that said reinforcing filler comprises a blend of 20-80% by weight of a carbon black classified as N1 or N2, and 80-20% by weight of carbon black classified as N5 or N6.

The reinforcing filler preferably comprises a blend of 20-80% by weight of carbon black classified as N1, and 80-20% by weight of carbon black classified as N6.

The methylene acceptor compound is preferably a phenol-formaldehyde resin.

The polymer base preferably comprises 40-80 phr of NR, and 20-60 phr of BR.

The methylene donor compound is preferably hexamethoxymethylmelamine.

The mix according to the present invention is preferably used for producing BEAD FILLERS, TREAD BASES, and TREAD UNDERLAYERS.

BEAD FILLER is the internationally used term for the polymer material filling the bead; TREAD BASE is the internationally used term for a radially inner layer of the tread; and TREAD UNDERLAYER is the internationally used term for underlayer between the tread and the tread belt.

### BEST MODE FOR CARRYING OUT THE INVENTION

The following are non-limiting examples for a clearer understanding of the invention, with the aid of the attached graph showing the stiffness and hysteresis performance of the same mix alongside variations in carbon black. More specifically, the examples shown refer to individual carbon blacks used on their own; individual carbon blacks combined with a phenolic resin; and blends of carbon blacks combined with phenolic resin. All the mixes in the graph contain a total of 40 phr of carbon black.

### Examples

Four control mixes (Ctrl 1-4) and five mixes according to the invention (A-E) were prepared. The control mixes comprise respectively: carbon black N3 only; carbon black N1 combined with carbon black N6, with no methylene acceptor compound; carbon black N1 combined with a methylene acceptor compound; and carbon black N6 combined with a methylene acceptor compound.

The mixes according to the invention comprise the carbon black blend according to the invention, combined with phenolic resin.

### —Mix Preparation—

(First Mixing Stage)

A stationary 230-270-litre tangential-rotor mixer was first loaded with the cross-linkable polymer base, and part of the carbon black (50 to 75% of the total used in the mix) to a fill factor of 66-72%.

The mixer was operated at a speed of 40-60 rpm, and the resulting mix unloaded on reaching a temperature of 140-160° C.

(Second Mixing Stage)

The rest of the carbon black and the methylene acceptor compound (if any) were added to the mix from the preceding stage. The mixer was operated at a speed of 40-60 rpm, and the mix unloaded on reaching a temperature of 130-150° C.

(Third Mixing Stage)

The curing agents and the methylene donor compound (if any) were added to the mix from the preceding stage, to a fill factor of 63-67%.

The mixer was operated at a speed of 20-40 rpm, and the resulting mix unloaded on reaching a temperature of 100-110° C.

Table I shows the compositions of the four control mixes in phr.

TABLE I

| | Ctrl 1 | Ctrl 2 | Ctrl 3 | Ctrl 4 |
|---|---|---|---|---|
| NR | 70 | | | |
| BR | 30 | | | |
| N3 | 40 | — | — | — |
| N1 | — | 20 | 40 | — |
| N6 | — | 20 | — | 40 |
| METHYLENE ACCEPTOR | — | — | 8 | 8 |
| COMPOUND | | | | |
| METHYLENE DONOR COMPOUND | — | — | 2.65 | 2.65 |

| | |
|---|---|
| SULPHUR | 3.5 |
| ACCELERATING AGENT | 1 |

NR is natural rubber; BR is butadiene rubber; the methylene acceptor compound is phenol-formaldehyde; the methylene donor compound is hexamethoxymethylmelamine; and the accelerating agent is TBBS.

The above mixes were cured and tested as per ASTM Standard D5992 to determine elastic modulus E′ (30° C.) and TanD (30° C.)

Table II shows the results indexed with respect to Ctrl mix 1.

TABLE II

| | Ctrl 1 | Ctrl 2 | Ctrl 3 | Ctrl 4 |
|---|---|---|---|---|
| E′ at 30° C. | 100 | 92 | 283 | 120 |
| TanD at 30° C. | 100 | 92 | 121 | 99 |

Table III shows the compositions in phr of the five mixes according to the present invention.

TABLE III

| | A | B | C | D | E |
|---|---|---|---|---|---|
| NR | 70 | | | | |
| BR | 30 | | | | |
| N1 | 10 | 20 | — | 20 | — |
| N2 | — | — | 20 | — | 20 |
| N5 | — | — | — | 15 | 15 |
| N6 | 15 | 15 | 15 | — | — |
| METHYLENE ACCEPTOR | 8 | | | | |
| COMPOUND | | | | | |
| METHYLENE DONOR | 2.65 | | | | |
| COMPOUND | | | | | |

| | |
|---|---|
| SULPHUR | 3.5 |
| ACCELERATING AGENT | 1 |

The compounds are the same as specified for Table I.

Table IV shows the elastic modulus E′ (30° C.) and TanD (30° C.) results measured as for Table II.

TABLE IV

| | A | B | C | D | E |
|---|---|---|---|---|---|
| E′ at 30° C. | 100 | 210 | 180 | 240 | 220 |
| TanD at 30° C. | 77 | 90 | 85 | 100 | 92 |

As shown clearly by comparing Tables II and IV, the mixes according to the present invention have the advantage of improving rolling resistance without compromising stiffness, and vice versa.

In fact, as shown in Table II, using carbon black with a mid-range surface area (Ctrl 1) or a combination of carbon blacks with no polymer resin (Ctrl 2), no significant improvement is achieved in either stiffness or hysteresis. Whereas, using high- or low-surface-area carbon blacks individually with polymer resin (Ctrl 3 and Ctrl 4) improves stiffness and hysteresis respectively, but seriously impairs the other characteristic.

In other words, the mixes according to the present invention allow rolling resistance or stiffness to be privileged selectively, without compromising the other characteristic.

1. A mix for a structural component of a tyre, comprising a cross-linkable polymer base; curing agents; and 20-100 phr of a reinforcing filler; said mix being characterized by comprising a methylene acceptor compound combined with a methylene donor compound; and in that said reinforcing filler comprises a blend of 20-80% by weight of a carbon black classified as N1 or N2, and 80-20% by weight of carbon black classified as N5 or N6.

2. A mix as claimed in claim 1, characterized in that said mix comprises 2-16 phr of said methylene acceptor compound.

3. A mix as claimed in claim 1, characterized in that said reinforcing filler comprises a blend of 20-80% by weight of carbon black classified as N1, and 80-20% by weight of carbon black classified as N6.

4. A mix as claimed in claim 1, characterized in that the methylene acceptor compound is a phenol-formaldehyde resin.

5. A mix as claimed in claim 1, characterized in that said methylene donor compound is hexamethoxymethylmelamine.

6. A mix as claimed in claim 1, characterized in that the polymer base comprises 40-80 phr of NR, and 20-60 phr of BR.

7. A tread underlayer, characterized by being made from a mix as claimed in claim 1.

8. A tread base, characterized by being made from a mix as claimed in claim 1.

9. A bead filler, characterized by being made from a mix as claimed in claim 1.

10. A tyre, characterized by comprising a structural component as claimed in claim 7.
